(19) United States
(12) Patent Application Publication
(10) Pub. No.: US 2008/0292425 A1
(43) Pub. Date: Nov. 27, 2008

(54) Threaded insert for receiving a threaded fastener in a composite panel

(76) Inventors: Victor Pineiros, Santa Margarita, CA (US); Wilhelm Schepergerdes, Santa Margarita, CA (US)

Correspondence Address: Charlette M. Crissman;Second Floor, 4550 California Avenue, Bakersfield, CA, 93309, US

(21) Appl. No.: 12/152,722

(22) Filed: May 16, 2008

Related U.S. Application Data
(60) Provisional application No. 60/930,791, filed on May 17, 2007.

(51) Int. Cl. F16B 37/04

(52) U.S. Cl. 411/92

(57) ABSTRACT

A threaded insert for use in a composite and/or honey-comb matrix has a nut member disposed within a plastic housing. The threads of the nut member have a free running thread section and a thread lock section. When a fastener is made up into the nut member, a surface on the nut member engages an opposite-facing surface on the plastic housing, thereby reversing the nut loading from tensile loading to compression loading. A thermoplastic embodiment of the nut member may be fabricated to meet the specifications of aircraft manufacturers required for the SL2334 insert, including thread reusability, tensile loading (pullout load), shear, and interchangeability with the metal component currently in use.

### CROSS-REFERENCE TO RELATED APPLICATION

U.S. Provisional Application No. 60/930,791 for this invention was filed on May 17, 2007, for which application these inventors claim domestic priority.

### BACKGROUND OF THE INVENTION

The present invention relates to an apparatus for attaching threaded fasteners, such as bolts, to a workpiece, which usually will have a first side, for which access is available, and a second side, which may be a blind side where access is not available. More particularly, this invention relates to a threaded insert, components of which are fabricated from non-metallic materials, generally from plastics, for use in a composite panel.

It is known to use threaded rivet nuts or threaded inserts as anchors for threaded fasteners in a number of different applications, such as installing anchors in sheet materials fabricated from metals, plastics and composites. One application of importance in the aircraft industry is using threaded inserts as anchors for carbon fiber sandwich panels which incorporate honeycomb and foam cores. In many cases, there is access only to one side of the workpiece, which are known as “blind” applications. It is to be understood that the term “workpiece” as used in this specification refers to any material for which it is desirable to use any of the disclosed embodiments of this device. Where there is only ready access to one side of a workpiece, it is necessary to employ anchors which may be completely deployed and installed on the visible side of the workpiece.

The use of threaded nut inserts compromising mostly metallic materials in carbon fiber materials presents some disadvantages when compared to threaded inserts primarily fabricated from non-metallic materials, such as plastic. For example, metallic inserts can form part of a corrosion cell resulting from the use of dissimilar materials resulting in galvanic corrosion.

With specific reference to airline applications, it is known to use metallic nut inserts in combination with plastic nut housings. However, metallic nut inserts weigh more than plastics. Given the relatively large number of metallic nut inserts utilized in an aircraft, the weight differential between metallic nut inserts and plastic nut inserts can result in greater fuel consumption by the aircraft, which may be substantial over the life of the aircraft. Metallic nut inserts may also present environmental concerns arising from the use of cadmium plating and the solvents and oils used in the machining operations required for the production of metallic inserts. However, thermoplastic nut inserts present their own problems, particularly where the insert is subjected to tensile loading. It is known that subjecting thermoplastic materials to tension loading can result in failure in the plastic component because of the creeping and cracking characteristics of thermoplastic materials. Therefore, creep generally precludes the use of plastic nut inserts.

In aircraft, plastic nut housings containing metallic nut inserts are potted or mechanically installed in sandwich material, like honeycomb, to allow the use of fasteners to fabricate the interior secondary structures of the aircraft, such as stow bins, galleys, and lavatories. A potted insert is generally installed by placing the insert into a pre-drilled hole in the material and adhesive is injected through an injection port in the top of the insert which allows for adhesive to flow around the insert and the composite material, where the other side of the top of the insert may comprise a vent hole to allow the venting of displaced air as adhesive is injected. The exterior surfaces of the insert may have various features, such as flow-control veins which prevent the creation of air pockets in the adhesive. A floating insert features a nut component which can move with respect to the rest of the insert to compensate for misalignment of the screw. The presently disclosed apparatus may comprise either the potted or mechanically installed variety where the nut floats within the plastic housing.

### SUMMARY OF THE INVENTION

The present invention is directed to a threaded insert for placement in a panel comprising composite material where the threaded insert meets the needs identified above. An embodiment of the threaded insert may comprise a nut member which is nested within a plastic housing. The nut member comprises internal threads for receiving the desired fastener. The nut member further comprises a head member and an integral cylindrical body depending from the head member. The head member comprises outwardly extending edge members, which may comprise diametrically opposed wing members. The cylindrical body of the nut member defines a longitudinal axis. The tops of the outwardly extending edge members comprise a first engagement surface which is normal, that is, perpendicular, to the first axis.

The plastic housing in which the nut member is nested is generally cylindrical in shape. The housing comprises a top and a bottom, where a longitudinal axis is defined by the top and the bottom. The plastic housing further comprises an internal surface which, in part, engages the nut member, and an external surface which engages the matrix of the composite panel either directly, or through an adhesive. The internal surface of the plastic housing comprises a cylindrical section which receives the cylindrical body of the nut member. The internal surface further comprising a grooved section for receiving the outwardly extending edge members of the nut member. The grooved section also comprises a second engagement surface which normal to the longitudinal axis. When a nut member is nested within the plastic housing and the outwardly extending edge members are set within the groove section, the first engagement surface of the outwardly extending edge members is in a generally opposite facing relationship with the second engagement surface (i.e., the first engagement surface is facing the second engagement surface), although there is not a complete overlap of the two surfaces. The external surface of the plastic housing may comprise anti-rotation members to prevent rotation of the threaded insert within the composite panel.

An embodiment of the disclosed plastic nut component may have a thread form which provides desirable properties for various applications, including aircraft applications utilizing sandwich panels fabricated from composite materials. This thread form has two components: (1) the free running portion of the threads; and (2) the thread lock portion. The number of free running threads is dependent on the overall height of the nut and the amount of locking torque encountered by the engaging bolt when the bolt first engages the beginning of the thread lock portion. The location and length of the thread lock portion is impacted by, among other factors, the amount of locking torque required, the overall nut height, the material from which the plastic nut is fabricated (i.e., the base polymer and fillers such as fiberglass, carbon fiber, minerals, etc.), and the number of desired reuses of the plastic nut in the particular application.

In the case of the disclosed housing, the orientation of the nut with respect to the housing is reversed, thereby reversing the nut loading from tensile loading to compression loading. The disclosed plastic housing may be injection molded in two symmetrical halves. The housing/insert assembly may be assembled by inserting the nut into a channel of a first half of the housing. Once the nut is inserted into the first half of the housing, the second half is snapped together with the first half and the assembly is complete and no further secondary assembly is required. Alternatively, the housing can be molded as a single component, where two halves are joined together with a hinge member. A nut member may then be placed between the two housing halves, and the halves folder over to enclose the nut member. folded over. In either case, the respective dimensions of the components of the plastic housing member and the nut member may allow for nut float such that initially engaging the threads of the nut member with a threaded fastener is facilitated.

### BRIEF DESCRIPTION OF THE DRAWINGS

FIG. 1 is a perspective view of an embodiment of the disclosed threaded insert, shown with half of the plastic housing removed.

FIG. 2 is perspective view of another embodiment of the disclosed threaded insert.

FIG. 3 is a side view of the embodiment of the threaded insert shown in FIG. 1.

FIG. 4 is a first perspective view of an embodiment of a nut member which may be utilized in the disclosed threaded insert.

FIG. 5 is second perspective view of the nut member shown in FIG. 4.

FIG. 6 is a plan view of the top of the embodiment of the nut member shown in FIG. 4.

FIG. 7 is a side view along the short side of the embodiment of the nut member shown in FIG. 4.

FIG. 8 is a side view along the long side of the embodiment of the nut member shown in FIG. 4.

FIG. 9 is a plan view of the bottom of an embodiment of the nut member shown in FIG. 4.

FIG. 10 is a sectional view along line 10-10 of FIG. 9.

FIGS. 11 and 12 are perspective views of the symmetrical halves of an embodiment of the disclosed plastic housing.

FIG. 13 is a plan view of the bottom of one half of the embodiment of the disclosed plastic housing shown in FIGS. 11 and 12.

FIG. 14 is a plan view of the top of one half of the embodiment of the disclosed plastic housing shown in FIGS. 11 and 12.

FIG. 15 is a side view of one half of the embodiment of the disclosed plastic housing shown in FIGS. 11 and 12 looking towards the outside of the housing.

FIG. 16 is a side view of one half of the embodiment of the disclosed plastic housing shown in FIGS. 11 and 12 looking toward the inside of the housing.

FIG. 17 is a front view of the embodiment of one half of the disclosed plastic housing shown in FIGS. 11 and 12.

FIG. 18 is a sectional view taken along line 18-18 of FIG. 17.

FIG. 19 is a sectional view taken along line 19-19 of FIG. 17.

FIG. 20 is a sectional view taken along line 20-20 of FIG. 17.

FIG. 21 is an exploded view showing the placement of an embodiment of a nut member within an embodiment of a plastic housing with respect to a threaded fastener.

FIG. 22 is a top exploded view of an embodiment of a nut member and two halves of an embodiment of the plastic housing.

FIG. 23 shows the placement of a nut insert within a composite panel.

### DETAILED DESCRIPTION OF THE EMBODIMENTS

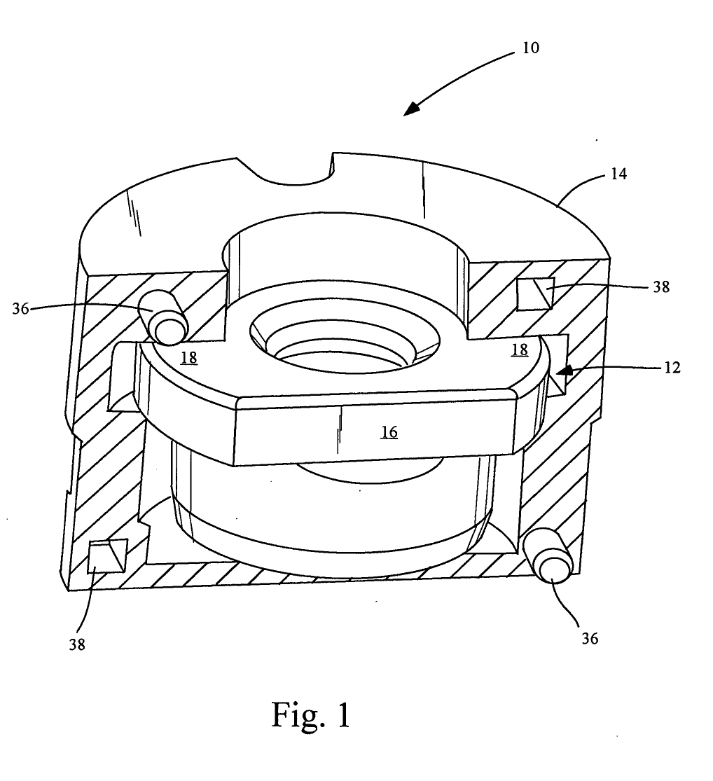

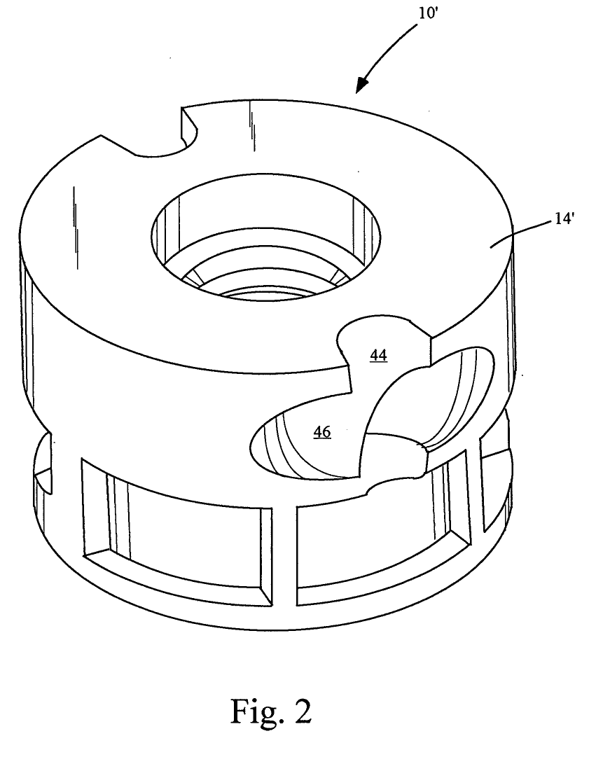

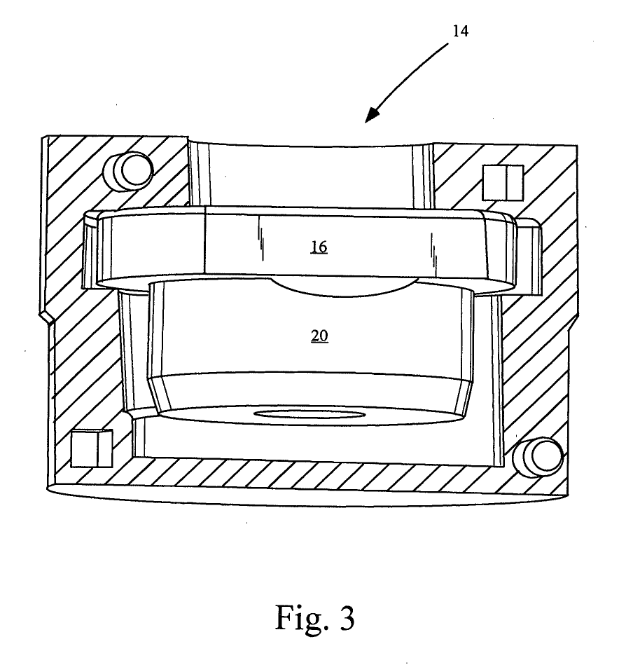

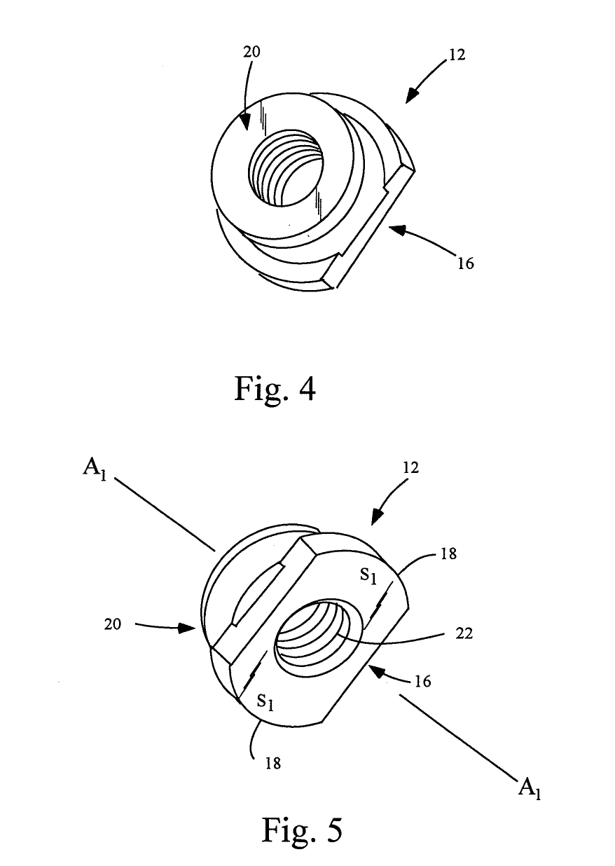

Referring now to the drawings, an embodiment 10 of the disclosed apparatus comprises a nut member 12 nested within nested within a plastic housing 14, a half of which is shown in FIG. 1. The nut member 12 comprises a head member 16, which comprises outwardly extending edge members 18. The nut member 12 further comprises a cylindrical body 20 which, along with the head member 16, are integral parts of the nut member 12, the cylindrical body depending from the head member. The nut member further comprises internal threads 22. Plastic housing 14 may be injection molded in two symmetrical halves, resulting in a half-housing as shown in many of the figures, for example FIG. 1 and FIG. 3. Alternatively, plastic housing 14 can be molded as a single component, with each side attached by a hinge member. At assembly, the housing 14 would be folded over with the nut member 12 disposed inside the housing. An alternative embodiment 10′ of the disclosed apparatus is shown in FIG. 2, wherein the plastic housing 14′ has rounder external features than the embodiment shown in FIG. 1.

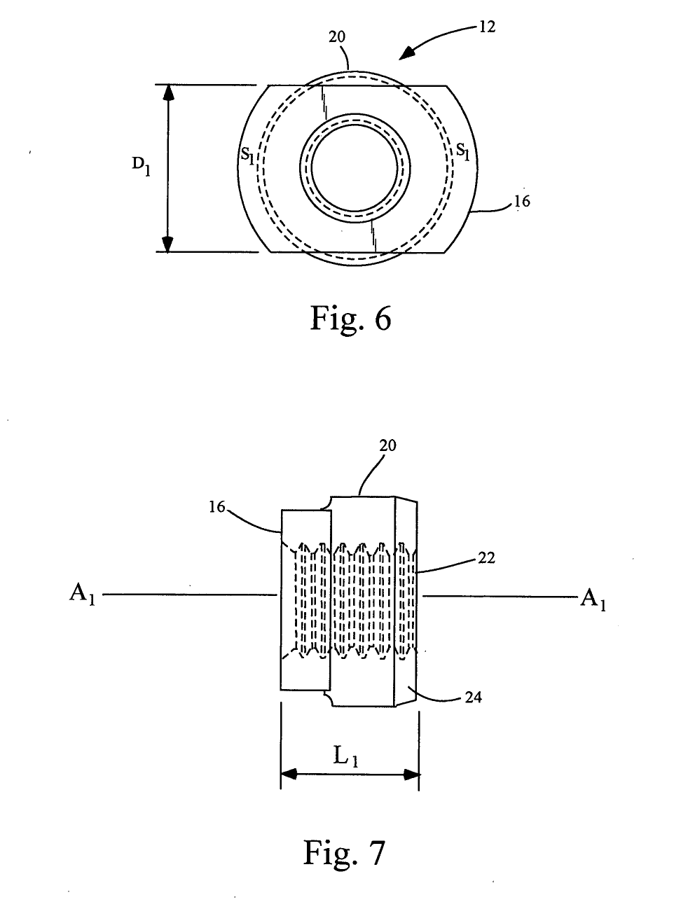

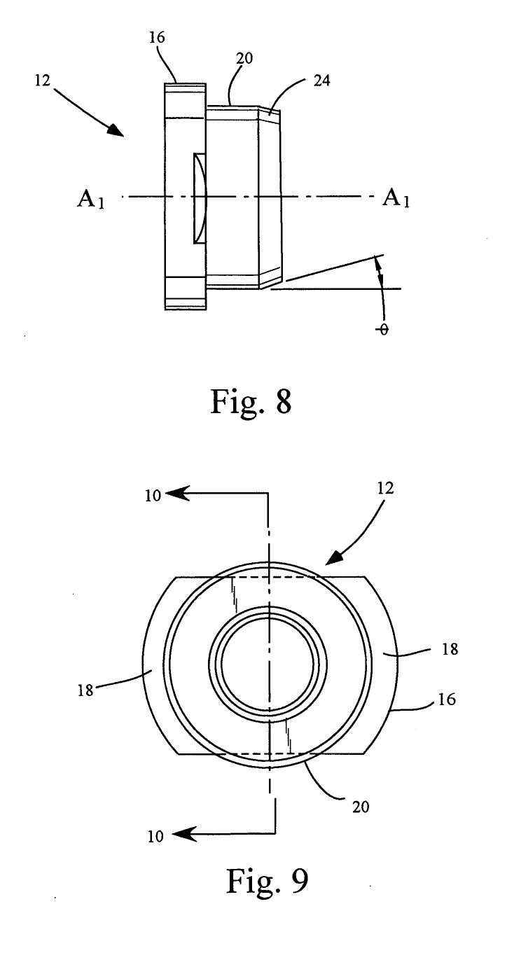

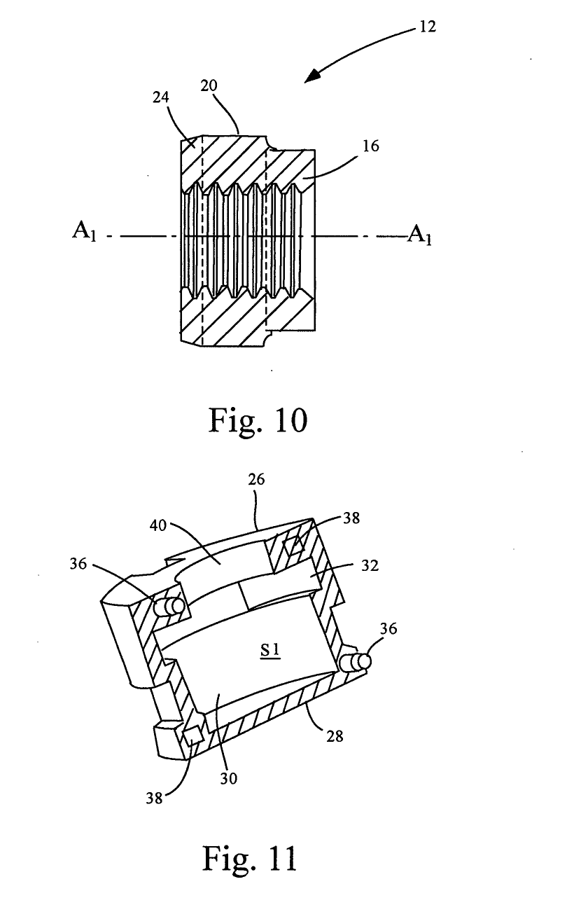

As shown in FIG. 6, head member 16 may have a short axis having a width of D₁, which, by way of example only, may range from 0.293 to 0.297 inches for some embodiments. Again, for purposes of example only, the overall length L₁ of an embodiment of nut member 16 may be approximately 0.210 inches. As best shown in FIG. 7, cylindrical body 20 may terminate with tapered end 24, which may have angle θ as shown in FIG. 8. As shown in FIG. 7, the cylindrical body 20 of nut member 12 defines a first axis A₁. The top of the outwardly extending edge members 18 comprises a first engagement surface S₁ which surface is normal to the first axis A₁. As generally shown in the figures, the outwardly extending edge members 18 may comprise diametrically opposed wing members, wherein the top surface of each wing member comprises the first engagement surface S₁.

Nut member 12 may comprise certain characteristics in order to meet specifications for aircraft applications. In particular, it may be desirable for nut member 12 to meet established requirements for reusability, tensile loading (pullout load), and thus be interchangeable with metallic assemblies currently in use. For example, a metallic component utilized in one aircraft application is the SL2334 insert. A thermoplastic embodiment of the disclosed nut member 12 may be fabricated to meet the specifications required for the SL2334 insert by the aircraft manufacturer, including thread reusability, tensile loading (pullout load), shear, and interchangeability with the metal component currently in use.

The form of threads 22 of nut member 12 may impose the desired locking torque on a fastener 100 by three different designs. First, the locking torque may be imposed by using differential pitch diameters; that is, the thread lock portion of the threads has a reduced pitch diameter from that of the free running portion of the threads. Second, the locking torque may be imposed by changing the thread flanks from 29.5° in the free running portion of the threads to an angle of lesser degree in the thread lock portion sufficient to create the required thread lock and life cycle. Third, a tapered thread may be utilized to create the thread lock.

Nut member 12 may be completely fabricated by injection molding, including the thread form. Nut member 12 may be fabricated such that the thread lock portion is located at either end of the nut member. However, for injection molding fabrication, the mandrel which produces the thread form needs to be extracted from the end of the nut adjacent to the free running thread portion. For embodiments which utilize differential pitch diameters for imposing locking torque, imperfect threads at the transition between the differential pitch diameters need to be kept at a minimum, particularly for shorter overall nut heights. It is to be appreciated that the disclosed plastic nut member 12 might also be fabricated from machining techniques. In fabricating the plastic nut member 12 with machining methods, for the embodiments utilizing differential pitch diameters for imposing locking torque, the finished thread locking pitch diameter is first completed and then the free running threads are machined to the calculated free running depth.

The preferred material for a thermoplastic embodiment of the nut member 12 is polyetherimide, such as the product sold under the ULTEM brand by GENERAL ELECTRIC. The preferred material for aircraft applications is ULTEM 2300, which is 30% glass reinforced material. However, in the appropriate application, an embodiment 10 of the disclosed apparatus may comprise a metallic nut member 12 fabricated from alloy steel, stainless steel or titanium, where the nut member is utilized with a plastic housing 14 as discussed below.

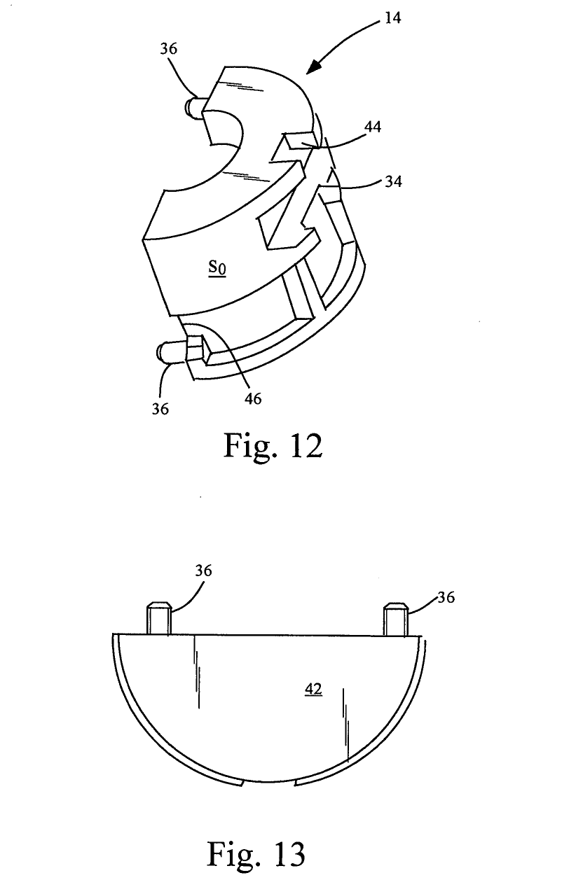

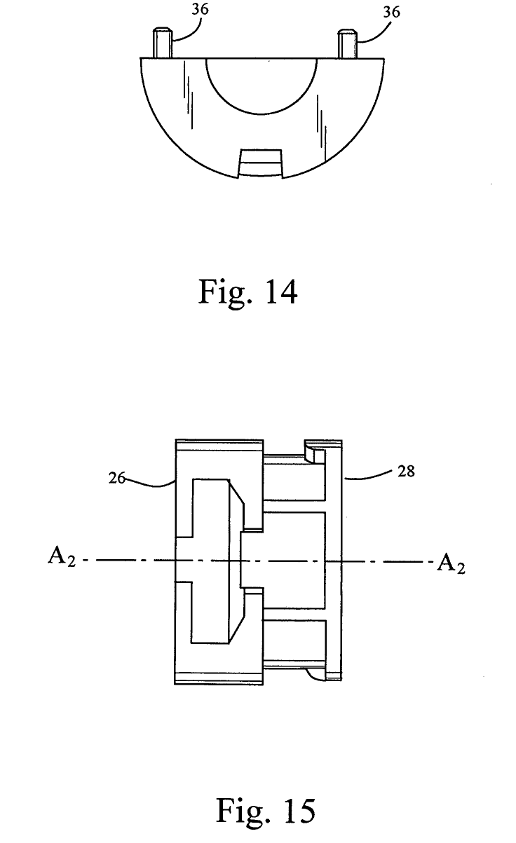

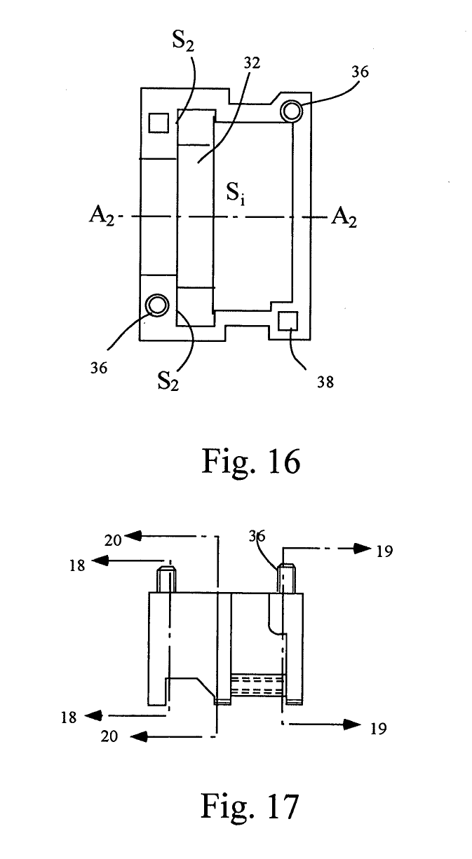

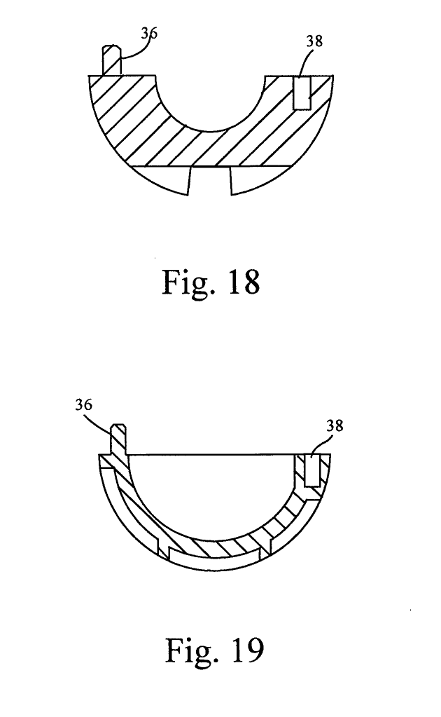

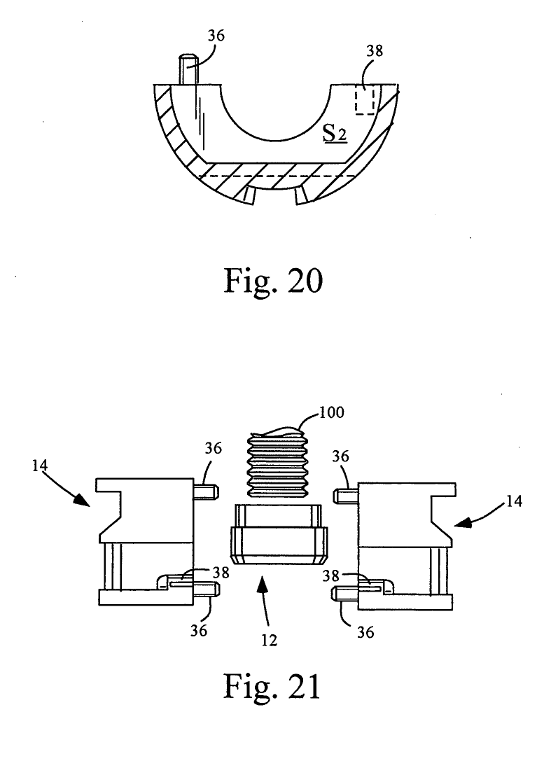

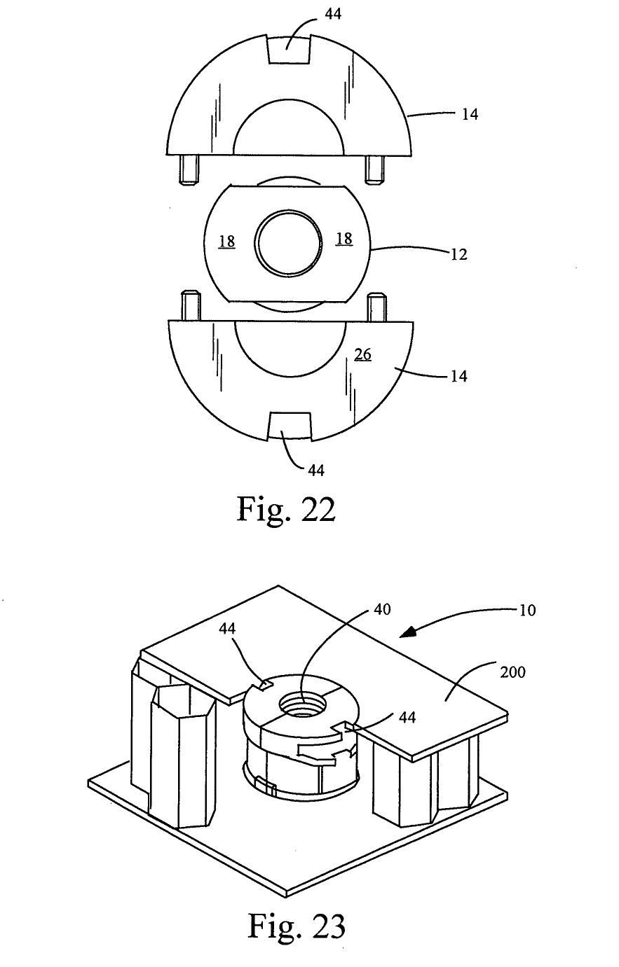

Various views of an embodiment of plastic housing 14 are shown in FIGS. 11 through 20. Plastic housing 14 has a top 26 and a bottom 28. The top 26 and bottom 28 define a longitudinal axis A₂. Plastic housing 14 has an internal surface Sᵢ and an external surface So. The internal surface Si comprises a cylindrical section 30 for receiving the cylindrical body 20 of the nut member 12. The internal surface Si further comprises a grooved section 32 for receiving the head member 16 of the nut member 12. As best shown in FIG. 20, grooved section 32 comprises a second engagement surface S₂ normal to longitudinal axis A₂. Assuming longitudinal axis A₂ is vertically oriented, with top 26 and bottom 28 respectively positioned, second engagement surface S₂ would be facing downward. When a fastener 100 is made up into the threads 22 of nut member 12, the nut member is pulled upwardly and first engagement surface S₁ of the nut member is brought into contact with second engagement surface S₂. As fastener 100 is tightened further, the nut member 12 is placed in compression by the engagement of the first engagement surface S₁ to the second engagement surface S₂. If nut member 12 comprises a thermoplastic material, placing the nut member in compression as opposed to the tension to which the nut member would otherwise be subjected prevents creep of the plastic nut member.

The external surface Sₒ of the plastic housing 14 may comprise anti-rotation members 34 to prevent rotation of the threaded insert within the composite panel 200. As discussed above, plastic housing 14 may be injection molded in two symmetrical halves, which may be connected together with pins 36 and corresponding sockets 38. Plastic housing 14 comprises an opening 40 in the top 26 into which fastener 100 may be inserted. The bottom 28 of plastic housing 14 is a solid end 42. Plastic housing 14 may also comprise various features which facilitate a potted installation, where adhesive is injected between the insert 10 and the composite structure 200. Some of these features include injection/ventilation ports 44. As can be seen in the figures, the exterior surface So may comprise various flow veins 46 for improved adhesive flow around the exterior of the plastic housing 14.

The preferred material for a thermoplastic embodiment of the plastic housing 14 is polyetherimide, such as the product sold under the ULTEM brand by GENERAL ELECTRIC. The preferred material for aircraft applications is ULTEM 2300, which is 30% glass reinforced material.

The disclosed plastic housing may be injection molded in two symmetrical halves. The housing/insert assembly may be assembled by inserting the nut into a channel of a first half of the housing. Once the nut is inserted into the first half of the housing, the second half is snapped together with the first half and the assembly is complete and no further secondary assembly is required. Alternatively, the housing can be molded as a single component, where two halves are joined together with a hinge member. A nut member may then be placed between the two housing halves, and the halves folder over to enclose the nut member. folded over. In either case, the respective dimensions of the components of the plastic housing member and the nut member may allow for nut float such that initially engaging the threads of the nut member with a threaded fastener is facilitated.

While the above is a description of various embodiments of the present invention, further modifications may be employed without departing from the spirit and scope of the present invention. For example, the dimensions and/or material of the plastic nut and plastic nut housing may be changed according to the needs of a particular application. Thus the scope of the invention should not be limited by the specific structures disclosed. Instead the true scope of the invention should be determined by the claims of the forthcoming utility application.

What is claimed is:

1. A threaded insert for receiving a threaded fastener in a composite panel, the threaded insert comprising:
a nut member nested within a plastic housing, the nut member comprising internal threads, the nut member further comprising a head member having outwardly extending edge members and a cylindrical body depending from the head member, the cylindrical body defining a first axis, the head member comprising a first engagement surface normal to the first axis;
the plastic housing comprising a top and a bottom defining a longitudinal axis, the plastic housing further comprising an internal surface and an external surface, the internal surface comprising a cylindrical section for receiving the cylindrical body of the nut member, the internal surface further comprising a grooved section for receiving the outwardly extending edges of the head member, the grooved section comprising a second engagement surface normal to the longitudinal axis, the first engagement surface and the second engagement surface in opposite facing relationship, the external surface of the housing comprising anti-rotation members to prevent rotation of the threaded insert within the composite panel.

2. The threaded insert of claim 1 wherein the outwardly extending edge members comprise diametrically opposed wing members, wherein the top surface of each wing member comprises the first engagement surface.

3. The threaded insert of claim 1 wherein the threads of the nut member comprise a free running thread section and a thread lock section.

4. The threaded insert of claim 3 wherein the thread lock section has a pitch diameter less than the pitch diameter of the free running thread section.

5. The threaded insert of claim 1 wherein the top of the plastic housing comprises a potting port for injection of the adhesive and a venting port.

6. The threaded insert of claim 1 wherein the external surface of the housing comprises flow control veins for directing the flow of an adhesive for bonding the threaded insert to the composite panel.

7. The threaded insert of claim 1 wherein the nut member comprises a thermoplastic material.

8. The threaded insert of claim 1 wherein the plastic housing comprises two symmetrical halves attached together with fastening means.

9. A threaded insert for receiving a threaded fastener in a composite panel, wherein the threaded insert is retained within the composite panel by an adhesive, the threaded insert comprising:
a nut member nested within a plastic housing, the nut member comprising internal threads, the nut member further comprising a head member having outwardly extending edge members and a cylindrical body depending from the head member, the cylindrical body defining a first axis, the head member comprising a first engagement surface normal to the first axis; and
the plastic housing comprising a top and a bottom defining a longitudinal axis, the plastic housing further comprising an internal surface and an external surface, the internal surface comprising a cylindrical section for receiving the cylindrical body of the nut member, the internal surface further comprising a grooved section for receiving the outwardly extending edge members, the grooved section comprising a second engagement surface normal to the longitudinal axis, the first engagement surface and the second engagement surface in opposite facing relationship, the top of the plastic housing comprising potting ports for injection of the adhesive.

10. The threaded insert of claim 9 wherein the nut member comprises a thermoplastic material.

11. The threaded insert of claim 9 wherein the outwardly extending edge members comprise diametrically opposed wing members, wherein the top surface of each wing member comprises the first engagement surface.

12. The threaded insert of claim 9 wherein the threads of the nut member comprise a free running thread section and a thread lock section.

13. The threaded insert of claim 12 wherein the thread lock section has a pitch diameter less than the pitch diameter of the free running thread section.

14. The threaded insert of claim 9 wherein the plastic housing comprises two symmetrical halves attached together with fastening means.

15. A threaded insert for receiving a threaded fastener in a composite panel, the threaded insert comprising:
a plastic nut member nested within a plastic housing, the plastic nut member comprising internal threads, the plastic nut member further comprising a head member and a cylindrical body depending there-from, the cylindrical body defining a first axis, the top of the head member comprising a first engagement surface normal to the first axis; and
the plastic housing comprising a top and a bottom defining a longitudinal axis, the plastic housing having an internal surface and an external surface, the internal surface comprising a cylindrical section for receiving the cylindrical body of the plastic nut member, the internal surface further comprising a grooved section for receiving the head member, the grooved section comprising a second engagement surface normal to the longitudinal axis, wherein the plastic nut member is placed in compression by the engagement of the first engagement surface to the second engagement surface as the fastener is made up into the internal threads of the nut.

16. The threaded insert of claim 15 wherein the head member comprises diametrically opposed wing members, wherein the top surface of each wing member comprises the first engagement surface.

17. The threaded insert of claim 15 wherein the threads of the nut member comprise a free running thread section and a thread lock section.

18. The threaded insert of claim 17 wherein the thread lock section has a pitch diameter less than the pitch diameter of the free running thread section.

19. The threaded insert of claim 15 wherein the plastic housing comprises two symmetrical halves attached together with fastening means.
